(19) United States
(12) Patent Application Publication
(10) Pub. No.: US 2015/0072652 A1
(43) Pub. Date: Mar. 12, 2015

(54) METHOD FOR MANAGING PREPAID WIRELESS ACCOUNTS

(71) Applicant: Carl Jibril Sulaiman, II, Pensacola, FL (US)

(72) Inventor: Carl Jibril Sulaiman, II, Pensacola, FL (US)

(21) Appl. No.: 14/482,041

(22) Filed: Sep. 10, 2014

Related U.S. Application Data
(60) Provisional application No. 61/876,335, filed on Sep. 11, 2013.
(60) Provisional application No. 61/876,345, filed on Sep. 11, 2013.

(51) Int. Cl. H04W 12/10; H04M 17/00

(52) U.S. Cl. CPC H04W 12/10; H04M 17/10
USPC 455/411

(57) ABSTRACT

The present invention is a method, system and software application for wireless phone number validation. The method comprises generally (1) engaging an external server to send API request to validation server with phone number and carrier information; (2) determining validation script method based on specific carrier; (3) initializing a first automated script sequence based on said specific carrier; (4) a means to navigate and log on to said specific carrier website; (5) running said first automated script sequence through said website to validate said phone number; (6) extracting validation response from said website; and (7) returning said validation response to said external server. The system comprises generally an external server to send and receive a validation request and response and a software application for validating a wireless number program on customer's wireless carrier to extract a validation response from wireless carrier's website.

### RELATED APPLICATIONS

This application claims priority to U.S. Provisional Application No. 61/876,335 filed Sep. 11, 2013 and 61/876,345 filed Sep. 11, 2013. The entire contents of the above application are hereby incorporated by reference as though fully set forth herein.

### FIELD

The present invention relates to the field of pre-paid wireless. More specifically, the present invention relates to methods, systems and software applications for managing pre-pair wireless accounts.

### BACKGROUND

While traditionally prepaid wireless airtime has been primarily sold by retail wireless stores where number verification and pin loading has been typically performed by a sales rep or the subscriber at the time of purchase, increasingly prepaid wireless airtime is now sold through 3rd party websites, mobile apps or automated IVR platforms. Typically when airtime is sold by these 3rd party electronic means there is no way to pre-verify the validity of the wireless number submitted if it is controlled by a second tier or lower wireless carrier, also known as an MVNO.

Mobile Virtual Network Operators (“MVNO”) seek to make money in the prepaid wireless market by leasing wireless telephone and data spectrum from the major wireless carriers and then sell the signal to the public through talk, data and web prepaid plans. With the market for prepaid wireless providers saturated, significant, game-changing innovations are needed to enable new MVNOs and POS providers to scale into a successful long-term player in the prepaid wireless market, such as Tracfone, Boost and Virgin Mobile. In order for MVNOs to remain competitive, they must improve revenue margins by increasing efficiency and expanding service coverage. As such, it is important for retailers that sell the services of the MVNO to increase efficiency and to reduce the number of rejected prepaid refills by validating MVNO wireless numbers quickly and easily.

A wireless phone number validation process lets users and administrators know if a prepaid wireless number is active, thus eliminating any input errors by checking the MVNO issued phone number in seconds after it is entered. While some customers give invalid wireless numbers to defraud the system, most errors are simply data entry mistakes. Wireless number validation serves to reduce the number of inconvenienced customers, refunded transactions, fraudulent charges and calls to customer service.

Wireless number validation systems are known in the prior art, but they are limited in that these systems can only identify numbers that are registered with Tier 1 carriers (T-Mobile, AT&T, Sprint, Verizon). Many consumers erroneously make payment to the wrong carrier for their prepaid services, as they choose the company to pay based on the phone's logo. There exists an inherent confusion in the minds of consumers between the carrier branding of their handset and the MVNO service provider for the phone. For example, Net10 is a Tier 2 carrier under AT&T; therefore it is necessary for the customer to properly refill their phone using Net10 and not AT&T. Thus, there exists a need for a system that can properly validate numbers provided by the millions of other Tier 2 and Tier 3 MVNOs.

### BRIEF SUMMARY OF THE INVENTION

The present invention seeks to meet these needs by providing a method for managing prepaid wireless accounts. In one embodiment of the present invention, a method for wireless phone number validation is disclosed wherein the specific MVNO number can be quickly and easily identified as “valid” or “invalid.” The present invention is a method for validating a wireless number comprising (1) engaging an external server to send API request to validation server with phone number and carrier information; (2) determining validation script method based on specific carrier; (3) initializing a first automated script sequence based on said specific carrier; (4) a means to navigate and log on to said specific carrier website; (5) running said first automated script sequence through said website to validate said phone number; (6) extracting validation response from said website; and (7) returning said validation response to said external server.

The method further comprises a second automated script sequence based on said specific carrier that is run through said website to validate said phone number in the event said first automated script sequence returns an error.

In a second embodiment of the present invention, a system for validating a wireless number for customer's wireless carrier is disclosed comprising generally an external server to send and receive a validation request and response and a software application for validating a wireless number program on customer's wireless carrier to extract a validation response from wireless carrier's website. In another embodiment of the present invention, the software application for validating a wireless number program on a customer's wireless carrier to extract a validation response from wireless carrier's website is disclosed comprising a plurality of predetermined validation scripts that correlate with a plurality of wireless carriers.

The software application further comprises a means to select a first validation script based on the customer's wireless carrier as well as a means to create a web session to run said first validation script through wireless carrier's website to extract the validation response. The software application may also comprise a means to select a second validation script based on the customer's wireless carrier to extract the validation response as well as a means to create a web session to run said second validation script through wireless carrier's website to extract the validation response. The second validation script is used generally in the event the first validation script does not return a response.

### BRIEF DESCRIPTION OF THE DRAWINGS

FIG. 1. FIG. 1 is a schematic diagram illustrating the number validator flow according to the present invention.

### DETAILED DESCRIPTION

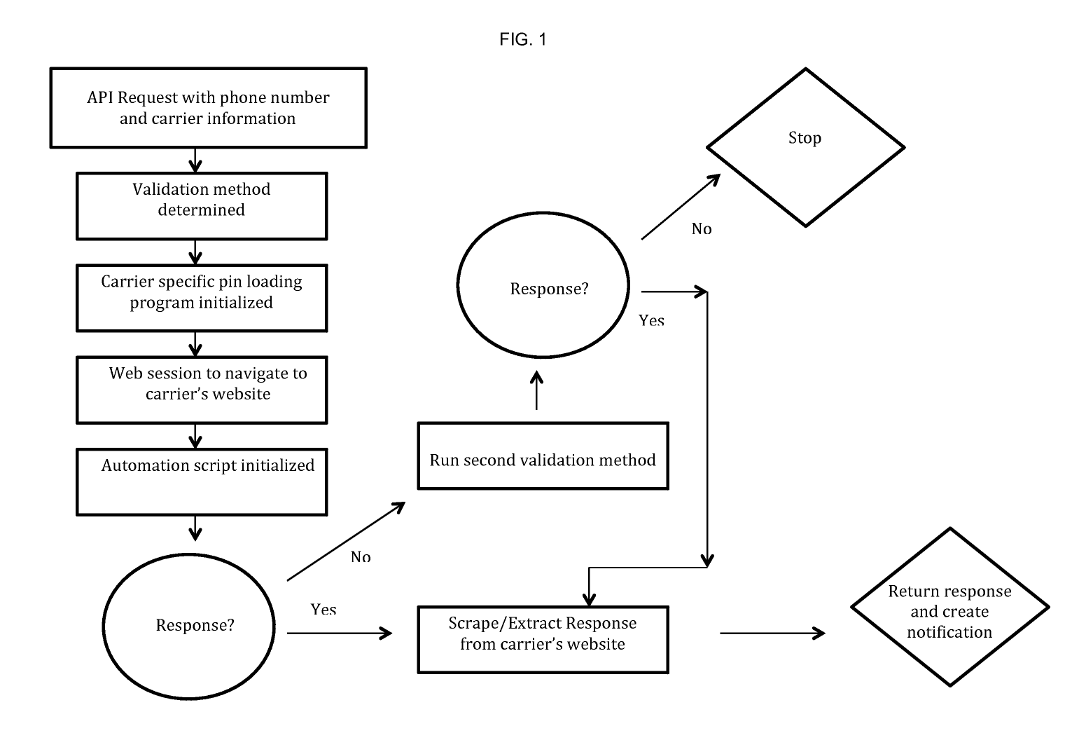

Turning to FIG. 1, the preferred method of the number validation is disclosed. First, an external server (the end customer) sends an API request to a validation server that includes the phone number and specific carrier information, such as “555-555-5555” and AT&T. Next, a validation server (the validation service provider) uses the specific carrier information to determine which validation script method is appropriate. Two examples of a simple validation scripts used with the present invention are set forth below; however, each specific carrier requires a unique validation script. Next, the validation script for the specific carrier is initialized. Then the automated validation script opens a web session and navigates to the website of the specific carrier. Next, the validation script is used to log on to the website of the specific carrier and attempts to validate the phone number with that specific carrier using the validation script sequence. The validation server scrapes and/or extracts the response from the specific carrier's website and then the validation server translates the response as “Valid” or “Invalid.” The validation server returns the response to the external server that initially made the API request (end customer).

In the event the first validation script run returns an error, the validation server runs a second script. Then the validation server scrapes and/or extracts the response from the specific carrier's website and the validation server translates the response as “Valid” or “Invalid.” The validation server returns the response to the external server that initially made the API request (end customer).

### EXAMPLES OF VALIDATION SCRIPTS

### Example 1

### Carrier=Simple Mobile

(1) access https://www.fastactportal.com/redemption?brand=SIMPLE_MOBILE

(2) Enter credentials user: thewirelessshoponline@gmail.com pass: 60016001

(3) Enter number 850-221-0432

(4) Valid Response Phone Status ACTIVE or Phone Status PAST DUE OR Phone Status PASTDUE

(5) INVALID RESPONSE Phone is not in a valid status

(6) Example of Valid Response

Provider Response: Phone Status ACTIVE

Service End Date

Wed May 29 06:34:51 EDT 2013

Brand

SIMPLE_MOBILE

(7) Example of Invalid Responses

Provider Response: Phone Status

PASTDUE

Service End Date

Fri Jan 01 00:00:00 EST 2010

Brand

NET_{—}10

(8) If the validator or web load gets this message then the servlet should try to log back in, up to 3 times.

Error 404—Not Found

From RFC 2068 Hypertext Transfer Protocol—HTTP/1.1:

10.4.5 404 Not Found

The server has not found anything matching the Request-URI. No indication is given of whether the condition is temporary or permanent. If the server does not wish to make this information available to the client, the status code 403 (Forbidden) can be used instead. The 410 (Gone) status code SHOULD be used if the server knows, through some internally configurable mechanism, that an old resource is permanently unavailable and has no forwarding address.

(9) INVALID RESPONSE

Phone Status—=BLANK

Service End Date=BLANK

Brand=BLANK

### Example 2

### Carrier=Simple Mobile

(1) access http://www.simplemobile.com/wps/portal/home/reup/reup/!ut/p/b1/

(2) INVALID response: The Phone Number entered is not found in our records or has an invalid status. Please check the number and try again.

(3) VALID Response: We offer great plans to meet your needs Please let us know if it is fine.

For the purposes of promoting an understanding of the principles of the invention, reference has been made to the preferred embodiments illustrated in the drawings, and specific language has been used to describe these embodiments. However, this specific language intends no limitation of the scope of the invention, and the invention should be construed to encompass all embodiments that would normally occur to one of ordinary skill in the art. The particular implementations shown and described herein are illustrative examples of the invention and are not intended to otherwise limit the scope of the invention in any way. For the sake of brevity, conventional aspects of the method (and components of the individual operating components of the method) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections might be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

What is claimed is:

1. A method for validating a customer's wireless number of customer's wireless carrier comprising:
(i) engaging an external server to send validation request;
(ii) navigating and logging on to customer's wireless carrier's website;
(iii) extracting validation response from wireless carrier's website; and
(iv) returning validation response to external server.

2. The method of claim 1 further comprising creating a web session with wireless carrier's website.

3. The method of claim 1 further comprising determining a first validation script based on customer's wireless carrier.

4. The method of claim 3 wherein the first validation script is used to extract the validation response from the wireless carrier's website.

5. The method of claim 4 wherein the validation response is valid or invalid.

6. The method of claim 11 further comprising determining a second validation script based on the customer's wireless carrier.

7. The method of claim 6 wherein the second validation script is used to extract the validation response from the carrier's website.

8. The method of claim 7 wherein the validation response is valid or invalid.

9. The method of claim 6 wherein the second validation script is only run in the event the first validation script does not extract a validation response.

10. A system for validating a wireless number for customer's wireless carrier comprising;
(i) an external server to send and receive a validation request and response; and
(ii) a software application for validating a wireless number program on customer's wireless carrier to extract a validation response from wireless carrier's website.

11. The system of claim 10 wherein the software program comprises a plurality of predetermined validation scripts that correlate with a plurality of wireless carriers.

12. The system of claim 11 wherein a first validation script is selected based on the customer's wireless carrier and used to extract the validation response.

13. The system of claim 12 wherein a second validation script is selected based on the customer's wireless carrier and used to extract the validation response.

14. The system of claim 13 wherein the second validation script is used in the event the first validation script does not extract a validation response.

15. A software application for validating a wireless number program on a customer's wireless carrier to extract a validation response from wireless carrier's website comprising a plurality of predetermined validation scripts that correlate with a plurality of wireless carriers.

16. The software application of claim 15 further comprising a means to select a first validation script based on the customer's wireless carrier.

17. The software application of claim 16 further comprising a means to create a web session to run said first validation script through wireless carrier's website to extract the validation response.

18. The software application of claim 16 further comprising a means to select a second validation script based on the customer's wireless carrier to extract the validation response.

19. The software application of claim 19 further comprising a means to create a web session to run said second validation script through wireless carrier's website to extract the validation response.

20. The software application of claim 19 wherein the second validation script is selected in the event the first validation script does not extract a validation response.
